(19) United States
(12) Patent Application Publication
(10) Pub. No.: US 2016/0170412 A1
(43) Pub. Date: Jun. 16, 2016

(54) AUTONOMOUS MOBILE DEVICE AND METHOD FOR CONTROLLING SAME

(71) Applicant: SHARP KABUSHIKI KAISHA, Osaka-shi, Osaka (JP)

(72) Inventors: Katsuhiro YAMAMOTO, Osaka-shi (JP); Tohru KUGA, Osaka-shi (JP)

(73) Assignee: SHARP KABUSHIKI KAISHA, Osaka-shi, Osaka (JP)

(21) Appl. No.: 14/905,622

(22) PCT Filed: Jun. 12, 2014
(86) PCT No.: PCT/JP2014/065543

§ 371 Date: Jan. 15, 2016

(30) Foreign Application Priority Data
Aug. 5, 2013 (JP) 2013-162118

(51) Int. Cl. G05D 1/00; G05D 1/02

(52) U.S. Cl. CPC G05D 1/0088; G05D 1/024

(57) ABSTRACT

In order to realize an autonomous mobile device which is compact and inexpensive and which is capable of almost simultaneously detecting (i) an obstacle present ahead of the autonomous moving device and (ii) a difference in level of a floor surface, an autonomous mobile device (1) of the present invention is an autonomous mobile device (1) which moves while detecting (i) an obstacle present ahead of the autonomous mobile device (1) and (ii) a difference in level of a floor surface, including: a laser range finder (21) which measures a distance to an object present in a scan area by scanning the scan area while emitting a laser beam in parallel to the floor surface; and mirrors (22a, 22b) each of which is provided within the scan area scanned by the laser range finder (21) and each of which reflects part of the laser beam to the floor surface.

### TECHNICAL FIELD

The present invention relates to an autonomous mobile device and a method of controlling an autonomous mobile device.

### BACKGROUND ART

Autonomous mobile devices, such as robots and automated guided vehicles, need to, while moving, detect (i) an obstacle present ahead of the autonomous mobile devices or (ii) a difference in level of a floor surface so as to avoid crashing or falling. An infrared or ultrasonic proximity sensor had been widely used to detect such an obstacle or a difference in level of a floor surface.

However, although the infrared or ultrasonic proximity sensor can determine whether or not an obstacle is present ahead of the autonomous mobile devices, it is not possible to determine a specific location or a specific shape of the obstacle. Therefore, in a case where the infrared or ultrasonic proximity sensor is mounted on a robot, it is not possible to use the robot for a case where the robot needs move while avoiding an obstacle present forward in a moving direction by calculating in advance a distance to the obstacle. In view of this, a distance sensor such as a laser range finder (LRF) has been used instead of such a proximity sensor.

FIG. 10 is a side view illustrating an autonomous mobile device 200 disclosed in Patent Literature 1. The autonomous mobile device 200 of Patent Literature 1 includes (i) a laser range finder 210 which measures a distance to an object present within a detection area, (ii) a reflective plate 220 which changes a direction of a laser beam 10 emitted from the laser range finder 210, and (c) a driving section 221 which drives the reflective plate 220.

The autonomous mobile device 200 is configured such that, in a case where an obstacle is detected which is present in a wide area extending forward in a moving direction, a direction of a light path of a laser beam L10 is changed to a horizontal direction by changing inclination of the reflective plate 220 so that the reflective plate 220 is arranged horizontally (see (a) of FIG. 10). The autonomous mobile device 200 is further configured such that, in a case where a difference in level of a floor surface is detected, the direction of the light path of the laser beam L10 is changed to a downward direction in a pitching direction by changing the inclination of the reflective plate 220 so that reflective plate 220 is arranged obliquely downward instead of being arranged horizontally (see (b) of FIG. 10).

That is, according to the autonomous mobile device 200 of Patent Literature 1, it is possible to, with use of a single laser range finder 210, detect both (i) a distance to an obstacle present ahead of the autonomous mobile device 200 and (ii) a degree of a difference in level of a floor surface, by driving the reflective plate 220 so that the direction of the laser beam L10 is changed between the horizontal direction and the downward direction.

### CITATION LIST

### Patent Literature

### [Patent Literature 1]

Japanese Patent Application Publication

Tokukai, No. 2011-96170 (Publication date: May 12, 2011)

### SUMMARY OF INVENTION

### Technical Problem

The autonomous mobile device 200 of Patent Literature 1 is, however, problematic in that, since frequently switching the inclination of the reflective plate 220 imposes a heavy load on the driving section 221, the inclination of the reflective plate 220 is fixed in practical use and accordingly, only either an obstacle or a difference in level of a floor surface is detected. Moreover, since a space or a cost for mounting the driving section 221, used to drive the reflective plate 220, is required, there is a problem that it is not possible to provide a compact and inexpensive autonomous mobile device 200.

The present invention has been made in view of the above problems, and an object of the present invention is to provide an autonomous mobile device which is compact and inexpensive and which is capable of almost simultaneously detecting (i) an obstacle present ahead of the autonomous mobile device and (ii) a difference in level of a floor surface.

### Solution to Problem

An autonomous mobile device of the present invention is an autonomous mobile device which moves while detecting (i) an obstacle present ahead of the autonomous mobile device and (ii) a difference in level of a floor surface, including: a distance sensor which measures a distance to an object present in a scan area by scanning the scan area while emitting a laser beam in parallel to the floor surface; and mirrors each of which is provided in the scan area scanned by the distance sensor and each of which reflects part of the laser beam toward the floor surface.

The autonomous mobile device of the present invention is arranged such that the mirrors are provided on respective right and left sides of the distance sensor.

The autonomous mobile device of the present invention is arranged so as to include: an auxiliary mirror provided between (a) the mirrors and (b) the floor surface, the auxiliary mirror reflecting the laser beam toward forward part or backward part of the floor surface.

A method of controlling an autonomous mobile device of the present invention is a method of controlling an autonomous mobile device recited in any one of claims 1 through 3, the method including the steps of: (a) detecting a difference in level of a floor surface while a laser beam is being emitted to each of mirrors; and (b) urgently stopping the autonomous mobile device in a case where the difference in level of the floor surface is outside an allowable range.

The method of controlling an autonomous mobile device of the present invention is arranged such that the difference in level of the floor surface is not detected while the laser beam is being emitted to an edge of each of the mirrors.

### Advantageous Effects of Invention

According to the present invention, it is possible to provide an autonomous mobile device which is compact and inexpensive and which is capable of almost simultaneously detecting (i) an obstacle present ahead of the autonomous mobile device and (ii) a difference in level of a floor surface.

### BRIEF DESCRIPTION OF DRAWINGS

FIG. 1 is a view schematically illustrating a configuration of an autonomous mobile device of the present invention.

FIG. 2 is a plan view illustrating a distance detecting section of the autonomous mobile device of the present invention.

FIG. 3 is a view schematically illustrating (i) arrangement of an LRF and mirrors and (ii) light paths of laser beams, in accordance with Embodiment 1.

FIG. 4 is a side view illustrating the autonomous mobile device in accordance with Embodiment 1.

FIG. 5 is a front view illustrating a reflective surface of a mirror.

FIG. 6 is a flowchart illustrating how to control the autonomous mobile device of the present invention.

FIG. 7 is a view schematically illustrating (i) arrangement of an LRF and mirrors and (ii) light paths of laser beams, in accordance with Embodiment 2.

FIG. 8 is a view schematically illustrating (i) another arrangement of an LRF and mirrors and (ii) light paths of laser beams, in accordance with Embodiment 2.

FIG. 9 is a side view illustrating an autonomous mobile device in accordance with Embodiment 3.

FIG. 10 is a side view illustrating a conventional autonomous mobile device.

### DESCRIPTION OF EMBODIMENTS

### Embodiment 1

The following description will discuss an embodiment of the present invention with reference to the drawings.

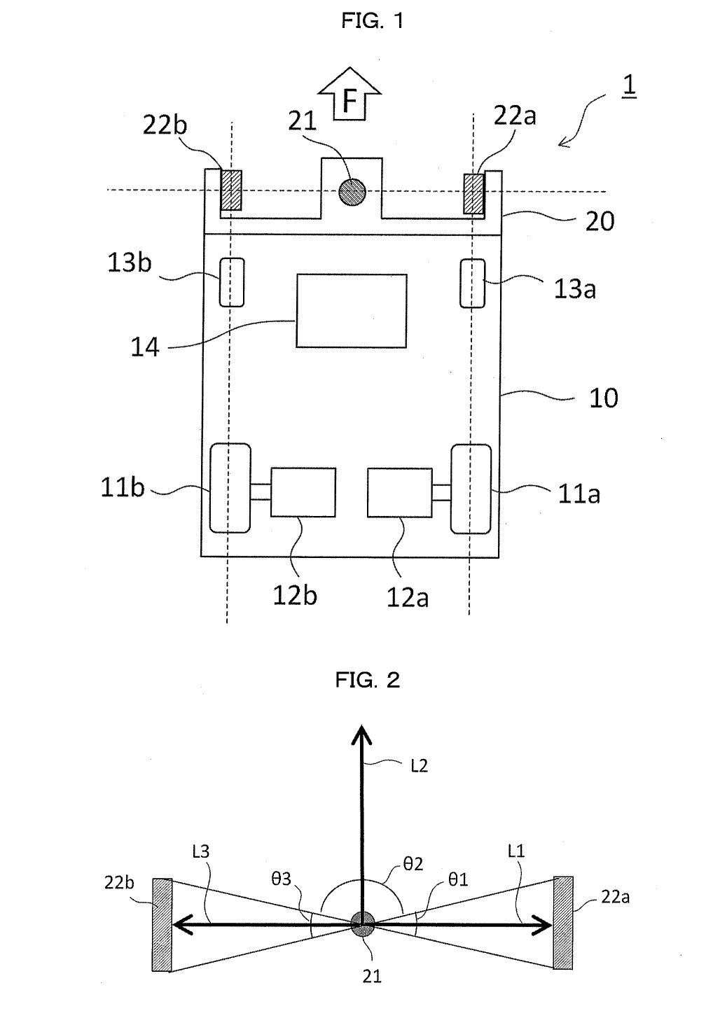

FIG. 1 is a view schematically illustrating a configuration of an autonomous mobile device 1 in accordance with Embodiment 1 of the present invention. The autonomous mobile device 1 includes a vehicle body 10 and a distance detecting section 20 provided on a front side of the vehicle body 10. The vehicle body 10 has a box shape. The distance detecting section 20 detects an obstacle and a difference in level of a floor surface. A driving wheel 11a, a motor 12a for driving the driving wheel 11a, and an auxiliary wheel 13a are provided on a right side of the vehicle body 10. Similarly, a driving wheel 11b, a motor 12b for driving the driving wheel 11b, and an auxiliary wheel 13b are provided on a left side of the vehicle body 10.

A laser range finder 21 (LRF), serving as a scanning-type distance sensor, is provided at a middle of the distance detecting section 20. Mirrors 22a and 22b each of which reflects a laser beam emitted from the laser range finder 21 are provided on respective right and left sides of the distance detecting section 20. The laser range finder 21 and the mirrors 22a and 22b are fixed at respective given positions with use of attaching angles (not illustrated). A positional relationship between the laser range finder 21 and the mirrors 22a and 22b will be later described in detail.

The autonomous mobile device 1 further includes a controlling section 14 for controlling the motors 12a and 12b, the laser range finder 21, and the like. The controlling section 14 communicates with the motors 12a and 12b via a cable (not illustrated), radio transmission (not illustrated), or the like, and controls a rotation frequency of each of the motors 12a and 12b, which are provided on the respective right and left sides of the vehicle body 10, so that the autonomous mobile device 1 moves forward or backward or turns around. Furthermore, the controlling section 14 communicates with the laser range finder 21 via a cable (not illustrated), radio transmission (not illustrated), or the like, and reads a value outputted by the laser range finder 21 so as to (i) calculate a distance to an obstacle present ahead the autonomous mobile device 1 or (ii) calculate a height from a floor surface to the mirrors 22a and 22b and determine whether or not there is a difference in level of the floor surface.

FIG. 2 is a plan view illustrating the distance detecting section 20 as viewed from above. A measuring principle of the laser range finder 21 is as follow. That is, the laser range finder 21 measures a distance to an object in accordance with time for a laser beam to be emitted, reflected by the object, and then return to the laser range finder 21 (time-of-flight). According to a scanning-type distance sensor, it is possible to measure a distance to an object present on a plane surface at a given height from a floor surface, by scanning a forward area in a fan-like manner while causing a laser beam emitted from a transmitter to be reflected by a spin mirror.

According to the autonomous mobile device 1 of the present invention, a scan area scanned by the laser range finder 21, which is of a scanning type, is divided into three areas θ1, θ2, and θ3, and laser beams L1 through L3 emitted to the respective areas θ1, θ2, and θ3 are individually used to detect (i) an obstacle present ahead of the autonomous mobile device 1 or (ii) a difference in level of a floor surface (see FIG. 2). Specifically, the laser beam L2 emitted to the area θ02 is emitted forward without being reflected, and used to detect an obstacle present on a plane surface at a given height from the floor surface. Meanwhile, the laser beam L1 emitted to the area θ1 is reflected toward the floor surface by the mirror 22a provided in the area θ1, whereas the laser beam L3 emitted to the area θ3 is reflected toward the floor surface by the mirror 22b provided in the area θ3. Each of the laser beams L1 and L3 is used to detect a difference in level of the floor surface. Note that the autonomous mobile device 1 of the present invention employs the laser range finder 21 which scans the scan area, including the three areas (θ1+θ2+θ3), that is at an angle of 270 degrees and which has a scanning rate of up to 15 times per second.

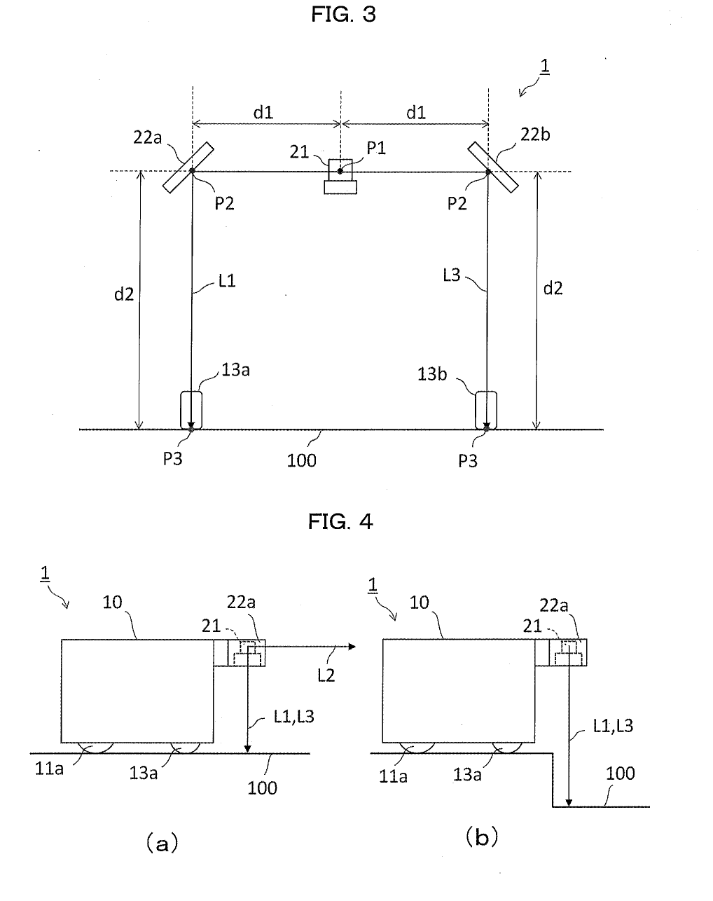

FIG. 3 is a view schematically illustrating, in the autonomous mobile device 1 of the present invention, (i) arrangement of the laser range finder 21 and the mirrors 22a and 22b and (ii) light paths of the laser beams L1 and L3 each emitted from the laser range finder 21. As the autonomous mobile device 1 is viewed from a front side, the laser range finder 21 is provided at the middle of the autonomous mobile device 1, and the mirrors 22a and 22b are provided on respective right and left sides of the laser range finder 21. The laser range finder 21 and the mirrors 22a and 22b are provided so as to be spaced out evenly by a distance d1. Furthermore, the laser range finder 21 and the mirrors 22a and 22b are provided such that (i) the laser range finder 21 and the mirrors 22a and 22b are arranged substantially in line and located, at respective positions each a distance d2 away from a floor surface 100, ahead of the auxiliary wheels 13a and 13b and (ii) the mirrors 22a and 22b are located on respective moving lines of the auxiliary wheels 13a and 13b.

In the above configuration, each of the mirrors 22a and 22b has a reflective surface inclined downward at an angle of 45 degrees. The laser beam L1 emitted from the laser range finder 21 to the area θ1 is reflected by the reflective surface of the mirror 22a, and then emitted to the floor surface 100 ahead of the auxiliary wheel 13a. Similarly, the laser beam L3 emitted from the laser range finder 21 to the area θ3 is reflected by the reflective surface of the mirror 22b, and then emitted to the floor surface 100 ahead of the auxiliary wheel 13b. On the other hand, the laser beam L2 emitted from the laser range finder 21 to the area θ2 is emitted, in parallel with the floor surface 100, ahead of the autonomous mobile device 1 without being reflected by any of the mirrors 22a and 22b.

FIG. 4 is a side view illustrating the autonomous mobile device 1 of the present invention. The autonomous mobile device 1 moves while carrying out a scan with use of the laser beams L1 and L3 emitted from the laser range finder 21 (see (a) of FIG. 4). In a case where the autonomous mobile device 1 approaches the floor surface 100 having a difference in level, the laser beams L1 and L3, which are reflected by the mirrors 22a and 22b, respectively, toward the floor surface 100, vary in time to be reflected by the floor surface 100 and then return to the laser range finder 21 (see (b) of FIG. 4). It is therefore possible to calculate a degree of the difference in level of the floor surface 100 by detecting such a difference in time. In a case where the controlling section 14 determines that the autonomous mobile device 1 cannot go over the difference in level of the floor surface 100, the controlling section 14 controls the autonomous mobile device 1 to be urgently stopped short of the difference in level of the floor surface 100. This makes it possible to prevent a risk of falling, tumbling, or the like of the autonomous mobile device 1.

Meanwhile, the laser beam L2 emitted from the laser range finder 21 to the area θ2 is emitted forward in parallel with the floor surface without being reflected by any of the mirrors. It is therefore possible to detect an obstacle present ahead of the autonomous mobile device 1 and to urgently stop the autonomous mobile device 1 before the autonomous mobile device 1 crashes into the obstacle.

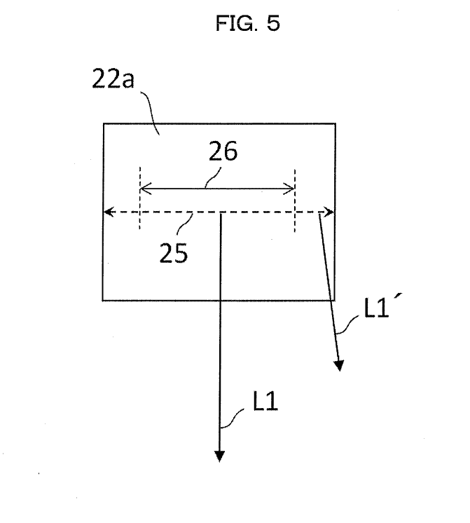

FIG. 5 is a view schematically illustrating the reflective surface of the mirror 22a as viewed from a laser range finder 21 side. The laser range finder 21 carries out a scan by emitting, along a broken line 25, the laser beam L1 to the reflective surface of the mirror 22a. Note here that an edge of the reflective surface causes the laser beam L1 to (i) be reflected diffusely as shown by a laser beam L1′ and (ii) not to travel straight toward the floor surface 100. In this case, it may not be possible to accurately detect a difference in level of the floor surface 100. In view of this, the whole of the area θ1 or θ2 is not used as a detection area in which the difference in level of the floor surface 100 is detected. Instead, an area, corresponding to a time period during which the laser range finder 21 carries out a scan by emitting the light beam L1 to a middle part 26 of the mirror 22a, is used as the detection area. This allows an improvement in accuracy of detection of a difference in level of the floor surface.

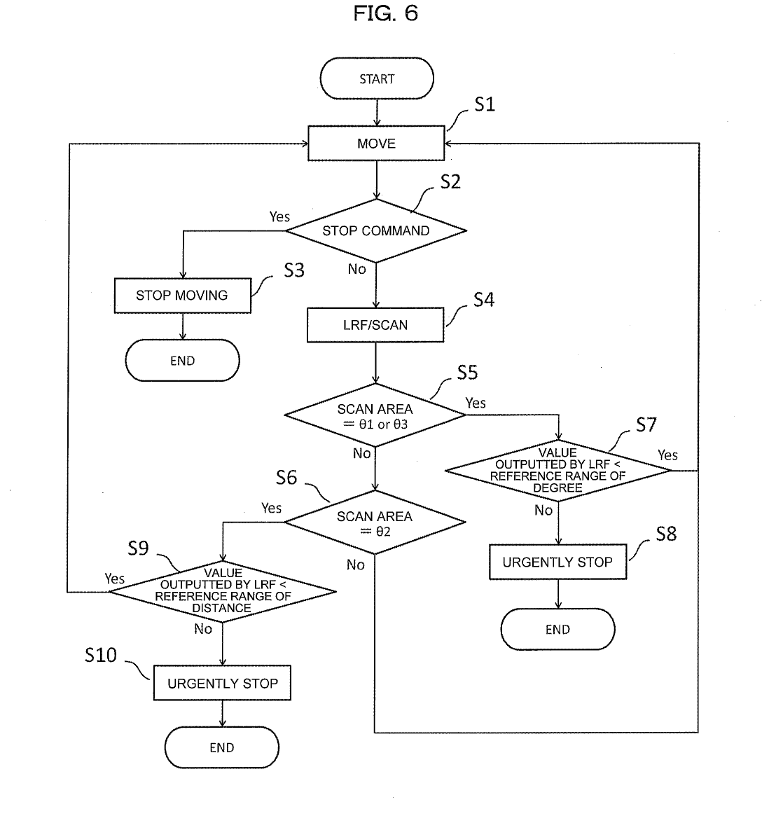

FIG. 6 is a flowchart illustrating how to control the autonomous mobile device 1 of the present invention. A method of controlling the autonomous mobile device 1 will be described below with reference to the flowchart of FIG. 6.

The controlling section 14 controls the motors 12a and 12b to drive the driving wheels 11a and 11b so that the autonomous mobile device 1 starts moving in a given direction (step S1). While the autonomous mobile device 1 is moving, the controlling section 14 determines whether or not the controlling section 14 has received a stop command (step S2). Note that the stop command is a command for intentionally causing movement of the autonomous mobile device 1 to be stopped. For example, the stop command may be incorporated in the autonomous mobile device 1 as a movement controlling program or alternatively inputted to the autonomous mobile device 1 by an external operating means. Upon receipt of the stop command, the controlling section 14 controls the motors 12a and 12b so that the autonomous mobile device 1 stops moving (step S3).

In the absence of the stop command, the controlling section 14 controls the autonomous mobile device 1 to continue moving in an autonomous movement mode. While the autonomous mobile device 1 is moving, the distance detecting section 20 detects an obstacle. In a case where the controlling section 14 determines that the obstacle is dangerous, the controlling section 14 controls the autonomous mobile device 1 to take an avoidance action.

In the autonomous movement mode, the controlling section 14 operates the laser range finder 21 so as to start a scan by emitting a laser beam (step S4). The controlling section 14 then determines which of the areas θ1 through θ3 the laser range finder 21 is scanning with use of the laser beam (steps S5 and S6). Note here that, as described with reference to FIG. 5, each area, in which detection accuracy is deteriorated, of the reflective surfaces of the mirrors 22a and 22b is excluded from the area θ1 or θ3. In a case where the laser range finder 21 is scanning such an area, the controlling section 14 determines “No” in the steps S5 and S6. In this case, the controlling section 14 controls a detection of an obstacle not to be carried out, returns a process to the step S1, and controls the autonomous mobile device 1 to continue moving.

In a case where the controlling section 14 determines in the step S5 that the laser range finder 21 is scanning the area θ1 or θ3 with use of the laser beam, the controlling section 14 controls the laser range finder 21 to detect a difference in level of the floor surface 100 with use of the laser beams L1 and L3 reflected by the mirrors 22a and 22b, respectively, toward the floor surface 100 (step S7). The controlling section 14 then determines whether or not a degree of the difference in level of the floor surface 100 falls within an allowable range in which the movement of the autonomous mobile device 1 is not interrupted. In a case where the degree of the difference in level of the floor surface 100 thus detected falls within the allowable range, the controlling section 14 returns the process to the step S1, and controls the autonomous mobile device 1 to continue moving. In a case where the degree of the difference in level of the floor surface 100 is outside the allowable range, the controlling section 14 determines that the difference is dangerous, and controls the autonomous mobile device 1 to be urgently stopped (step S8).

On the other hand, in a case where the controlling section 14 determines in the step S6 that the laser range finder 21 is scanning the area θ2 with use of the laser beam, the controlling section 14 controls the laser range finder 21 to detect an obstacle present ahead of the autonomous mobile device 1 with use of the laser beam L2 emitted ahead of the autonomous mobile device 1 (step S9). The controlling section 14 then determines whether or not a distance to the obstacle falls within an allowable range. In a case where the distance thus detected to the obstacle falls within the allowable range in which the movement of the autonomous mobile device 1 is not interrupted, the controlling section 14 returns the process to the step S1, and controls the autonomous mobile device 1 to continue moving. In a case where the distance to the obstacle is outside the allowable range, the controlling section 14 determines that the distance is dangerous, and controls the autonomous mobile device 1 to be urgently stopped (step S10).

According to the method of controlling the autonomous mobile device 1 of the present invention, the laser range finder 21 carries out a scan with use of a laser beam. The laser range finder 21 detects (i) an obstacle present ahead of the autonomous mobile device 1 while emitting the laser beam forward and (ii) a difference in level of the floor surface 100 while emitting the laser beam to any one of the mirrors. It is therefore possible to provide an autonomous mobile device which is compact and inexpensive and which is capable of almost simultaneously detecting (i) an obstacle present ahead of the autonomous mobile device and (ii) a difference in level in a floor surface.

### Embodiment 2

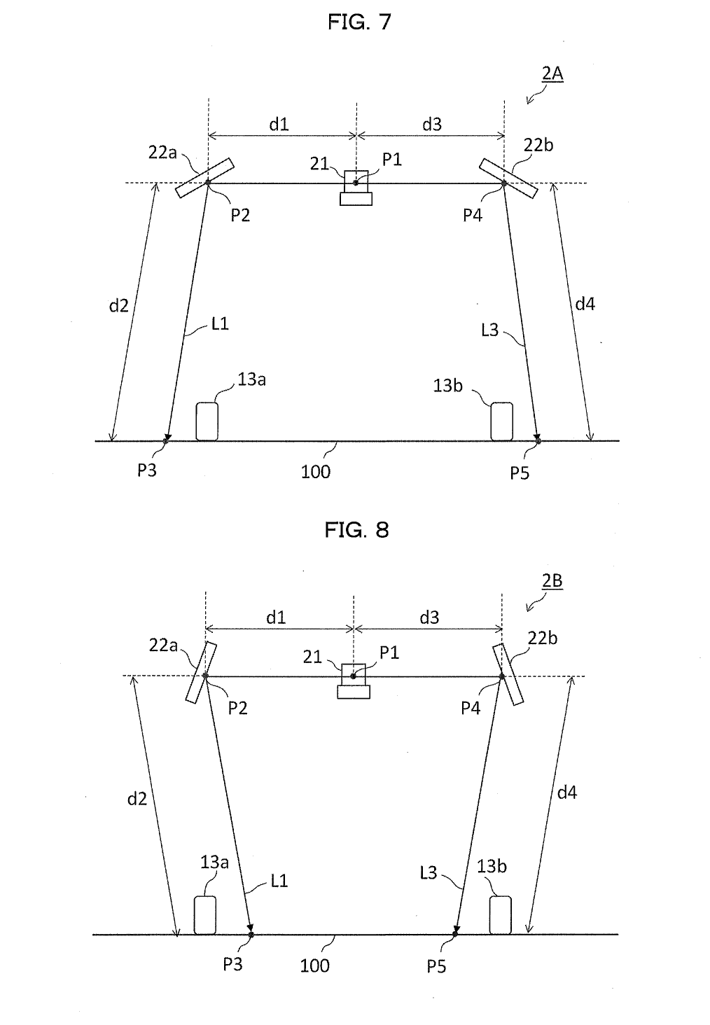

FIGS. 7 and 8 are schematic views for explaining configurations of autonomous mobile devices 2A and 2B, respectively, in accordance with Embodiment 2 of the present invention. The configurations of the autonomous mobile devices 2A and 2B of Embodiment 2 are different from that of the autonomous mobile device 1 of Embodiment 1 in that arrangement of mirrors 22a and 22b is modified. In the other points, the configurations of the autonomous mobile devices 2A and 2B of Embodiment 2 are identical to that of the autonomous mobile device 1 of Embodiment 1 and accordingly, identical descriptions will be omitted.

According to the configuration of the autonomous mobile device 2A illustrated in FIG. 7, inclination angles of the mirrors 22a and 22b are each set to less than 45 degrees so that positions to which respective laser beams L1 and L3 are emitted are located outside respective moving lines of auxiliary wheels 13a and 13b. The configuration of the autonomous mobile device 2A allows a detection of a position of a wall surface by causing the laser beam L1 or L3 to be emitted to the wall surface, in a case where the autonomous mobile device 2A, for example, approaches the wall surface. It is therefore possible to cause the autonomous mobile device 2A to move along the wall surface.

According to the configuration of the autonomous mobile device 2B illustrated in FIG. 8, inclination angles of the mirrors 22a and 22b are each set to more than 45 degrees so that positions to which respective laser beams L1 and L3 are emitted are located inside respective moving lines of auxiliary wheels 13a and 13b. The configuration of the autonomous mobile device 2B allows a detection, with use of the laser beam L1 or L3, of a dust or like present within an area in which the autonomous mobile device 2B moves, in a case where the autonomous mobile device 2B is, for example, used as an automated cleaning robot.

Note that the positions to which the respective laser beams are emitted can be adjusted by, instead of adjusting the inclination angles of the mirrors 22a and 22b, adjusting a distance dl from a laser range finder 21 to the mirrors 22a and 22b or alternatively adjusting both of the inclination angles of the mirrors 22a and 22b and the distance d1.

For example, in FIG. 7, by (i) setting each of the inclination angles of the mirrors 22a and 22b to less than degrees and (ii) shortening the distance d1, it is possible to cause the laser beams to be emitted to a floor surface 100 on the moving lines ahead of the auxiliary wheels 13a and 13b, as with the case of Embodiment 1. In this manner, it is also possible to freely change light paths of the laser beams L1 and L3 without changing the positions to which the laser beams L1 and L3 are emitted. This allows the autonomous mobile devices 2A and 2B to be arranged such that the light paths of the laser beams do not interfere with another member.

### Embodiment 3

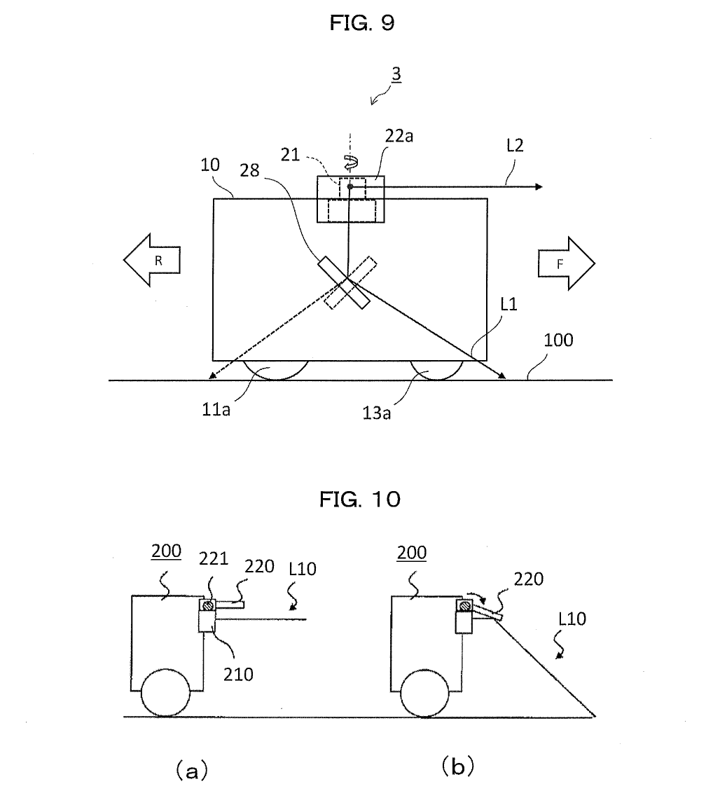

FIG. 9 is a side view for explaining a configuration of an autonomous mobile device 3 in accordance with Embodiment 3 of the present invention. The configuration of the autonomous mobile device 3 of Embodiment 3 is different from that of the autonomous mobile device 1 of Embodiment 1 in that (i) a laser range finder 21 and mirrors 22a and 22b are provided at respective middle positions between a front side and a rear side of a vehicle body 10 and (ii) an auxiliary mirror 28 is further provided. In the other points, the configuration of the autonomous mobile device 3 of Embodiment 3 is identical to that of the autonomous mobile device 1 of Embodiment 1 and accordingly, identical descriptions will be omitted.

As illustrated in FIG. 9, the autonomous mobile device 3 of Embodiment 3 is configured such that (i) the laser range finder 21 and the mirrors 22a and 22b are provided at the respective middle positions between the front side and the rear side of the vehicle body 10 and (ii) the auxiliary mirror 28, capable of changing an inclination of its reflective surface, is further provided between (a) the mirrors 22a and 22b and (ii) a floor surface 100. According to the autonomous mobile device 3, by changing the inclination of the reflective surface of the auxiliary mirror 28, it is possible to cause laser beams L1 and L3, reflected by the mirror 22a and 22b toward the floor surface near a middle of the vehicle body 10, to reflect toward the floor surface ahead of auxiliary wheels 13a and 13b or toward the floor surface behind driving wheels 11a and 11b.

Therefore, according to the autonomous mobile device 3 of Embodiment 3, it is possible to detect a difference in level of the floor surface 100 while the autonomous mobile device 3 is moving both forward and backward, by (i) causing the laser beams L1 and L3 to be emitted toward the floor surface ahead of the auxiliary wheels 13a and 13b while the autonomous mobile device 3 is moving forward (arrow F) and (ii) causing the laser beams L1 and L3 to be emitted toward the floor surface behind the driving wheels 11a and 11b while the autonomous mobile device 3 is moving backward.

Note that the autonomous mobile device 3 can be arranged such that, by rotating the laser range finder 21 by 180 degree so as to carry out a scan by emitting a laser beam L2 backward, an obstacle present on a back side of the autonomous mobile device 3 is detected while the autonomous mobile device 3 is moving backward.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to a business-use cleaning machine, an industrial transfer robot, and the like.

### REFERENCE SIGNS LIST

L1, L2, L3, L10 Laser beam
1, 2A, 2B, 3 Autonomous mobile device
10 Vehicle body
11a, 11b Driving wheel

### 12a, 12b Motor

13a, 13b Auxiliary wheel
14 Controlling section
20 Distance detecting section
21 Laser range finder

### 22a, 22b Mirror

28 Auxiliary mirror
100 Floor surface

1. An autonomous mobile device which moves while detecting (i) an obstacle present ahead of the autonomous mobile device and (ii) a difference in level of a floor surface, comprising:
a distance sensor which measures a distance to an object present in a scan area by scanning the scan area while emitting a laser beam in parallel to the floor surface; and
mirrors each of which is provided in the scan area scanned by the distance sensor and each of which reflects part of the laser beam toward the floor surface.

2. The autonomous mobile device as set forth in claim 1, wherein the mirrors are provided on respective right and left sides of the distance sensor.

3. An autonomous mobile device as set forth in claim 1, further comprising:
an auxiliary mirror provided between (a) the mirrors and (b) the floor surface,
the auxiliary mirror reflecting the laser beam toward forward part or backward part of the floor surface.

4. A method of controlling an autonomous mobile device recited in claim 1, the method comprising the steps of:
(a) detecting a difference in level of a floor surface while a laser beam is being emitted to each of mirrors; and
(b) urgently stopping the autonomous mobile device in a case where the difference in level of the floor surface is outside an allowable range.

5. The method as set as forth in claim 4, wherein the difference in level of the floor surface is not detected while the laser beam is being emitted to an edge of each of the mirrors.
